(19) United States
(12) Patent Application Publication
(10) Pub. No.: US 2008/0243903 A1
(43) Pub. Date: Oct. 2, 2008

(54) Data driven media interaction

(75) Inventors: Hugh C. Vidos, Sammamish, WA (US); Erin P. Honeycutt, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/729,645

(22) Filed: Mar. 29, 2007

(51) Int. Cl. G06F 7/00

(52) U.S. Cl. 707/102

(57) ABSTRACT

An extensible framework that facilitates user interaction with media items (e.g., digital content). Abstraction between a user's exploration experience via a user interface component and underlying data and behavior layers is provided. A data source component provides information associated with media item(s) and a behavior component provides information associated with action(s) associated with the media item(s) to the user interface component. Separation of the user interface from the underlying data and behavior layers facilitates recognition of additional media types without modification of the user interface component as the modifications occur within the data source component and the behavior component. As such, the user interface component can be maintained independent of modifications to the data source component and/or the behavior component.

### BACKGROUND

The availability of computer systems has dramatically increased in recent years. In particular, computer systems have become common in personal use. With this increased availability of personal computer systems, consumers have demanded increased functionality. For example, personal computer systems are no longer only used for simple tasks such as basic word processing tasks and balancing of the family checkbook. Users are more frequently turning to the personal computer system to explore a rich and vast universe of digital content.

Digital content can include, for example, audio content (e.g., music, voice, etc.), digital photographs, videos, movies, and television (e.g., high definition digital). Digital content can be stored (e.g., in file(s)) and/or be available in streaming format (e.g., via the Internet), for example, radio broadcasts.

Digital content can be stored locally on a personal computer system hard drive, memory storage device, CD, DVD, and the like. Additionally, an enormous quantity of digital content can be available via the Internet. Further complicating the user's exploration of digital content, the digital content can be retrieved in a variety of formats, for example, music can be stored in files, in a propriety format and/or in a stream from the Internet.

The volumes of digital content available can be a valuable resource for users. However, the volume of digital content can be intimidating for even the most experienced user to navigate. For example, a user may recall taking a digital photograph of a particular event, but not be able to recall where the user stored the digital photograph or the computer program used to retrieve the digital photograph.

### SUMMARY

The following presents a simplified summary in order to provide a basic understanding of novel embodiments described herein. This summary is not an extensive overview, and it is not intended to identify key/critical elements or to delineate the scope thereof. Its sole purpose is to present some concepts in a simplified form as a prelude to the more detailed description that is presented later.

An extensible framework that facilitates user interaction with media item(s) (e.g., digital content) is provided. The framework provides abstraction between a user's exploration experience and underlying data and behavior layers. By separating the exploration experience from the underlying data and behavior layers, the exploration experience can quickly support additional media types, for example, without changing exploration experience software/firmware.

The framework includes a computer-implemented system for interacting with media. The system includes a data source component that provides information associated with a media item and a behavior component that provides information associated with action(s) associated with the media item. The system further includes a user interface component (e.g., gallery) for displaying information associated with media items (e.g., music, digital photographs, videos etc) received from the data source component. The user interface component also displays action(s) associated with the media items based upon information received from the behavior component.

Thus, within the framework, the user interface component is functionally independent of the data source component and the behavior component. As media type(s) are modified, the user interface component does not need to be modified in order to support the modification. The modifications occur within the data source component and the behavior component. As such, the user interface component can be maintained independent of modifications to the data source component and/or the behavior component.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system for interacting with media.

FIG. 2 illustrates an alternative computer-implemented system for interacting with media.

FIG. 3 illustrates a computer-implemented system for interacting with media including a behavior registry and a data source location store.

FIG. 4 illustrates an exemplary user interface depicting actions associated with media items of a same type.

FIG. 5 illustrates an exemplary user interface depicting actions associated with media items of differing types.

FIG. 6 illustrates an exemplary user interface of a media item and related media items.

FIG. 7 illustrates an exemplary user interface for displaying a media item in a consumption area and associated metadata in a details area.

FIG. 8 illustrates a method of displaying information related to media items.

FIG. 9 illustrates a method of recognizing an additional media type.

FIG. 10 illustrates a computing system operable to execute the disclosed architecture.

FIG. 11 illustrates an exemplary computing environment.

### DETAILED DESCRIPTION

The disclosed architecture facilitates user interaction with media (e.g., digital content) within an extensible framework. In the framework, a user interface component (e.g., gallery) displays information associated with media items (e.g., music, digital photographs, videos etc) received from a data source component. The user interface component also displays action(s) associated with the media items based upon information received from a behavior component. The data source component stores information associated with the media items and information regarding location(s) of the media items. The behavior component stores action(s) associated with a type of data source

Thus, within the framework, the user interface component is functionally independent of the data source component and the behavior component. As media type(s) are modified, the user interface component does not need to be modified in order to support the modification. The modifications occur within the data source component and the behavior component. As such, the user interface component can be maintained independent of modifications to the data source component and/or the behavior component. The user experience can thus be enhanced to support additional media types without modifications to the user interface component.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

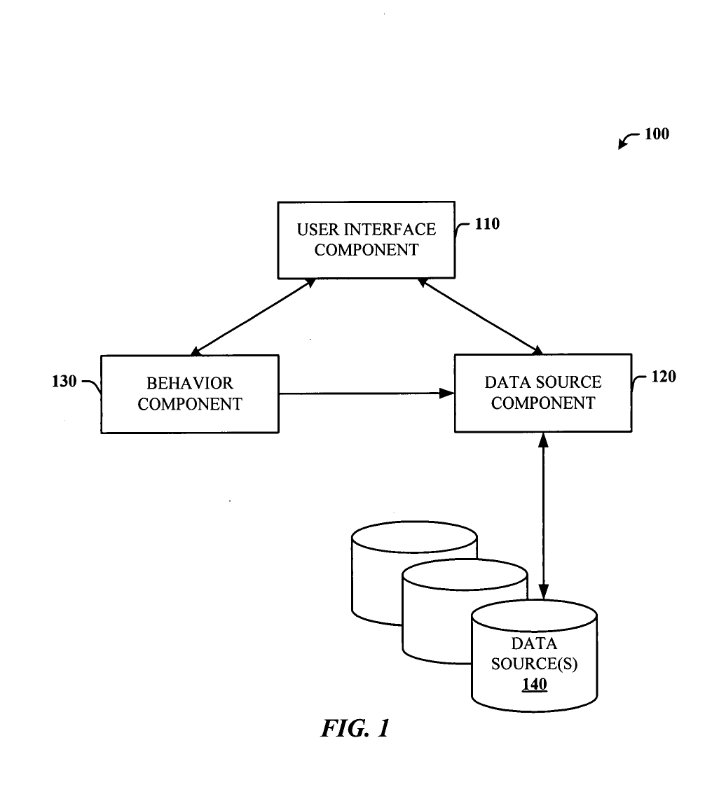

Referring initially to the drawings, FIG. 1 illustrates a computer-implemented system 100 for interacting with media (e.g., digital content). The system 100 can facilitate a user's exploration of media (e.g., music, digital photographs, movies, television, etc.) within an extensible framework.

The system 100 includes a user interface component 110 for displaying information associated with one or more media items and associated action(s). The user interface component 110 receives information associated with the media items from a data source component 120 (e.g., metadata, thumbnails, etc.). The data source component 120 stores information associated with the media items and information regarding location(s) of the media items. In one embodiment, the media items are of one particular type, for example, music, digital photographs, movies, television, etc.

The user interface component 110 can further receive information associated with action(s) associated with a type of the media items from a behavior component 130. The behavior component 130 stores action(s) associated with types of media. For example, the behavior component 130 can store “play” for a music media type. The type of media item can include, for example, a digital photograph file, an audio file, a movie file, a video file, a video stream, an audio stream, and the like.

In one embodiment, the user interface component 110 can display information to a user in a gallery format. In this example, a particular gallery can display a collection of media items of the same media type. For example, the user can select a gallery displaying information associated with music media items from one or more data sources 140.

In this example, the user interface component 110 can obtain information associated with music media items from the selected data sources 140 from the data source component 120. Additionally, the user interface component 110 can obtain information associated with action(s) available for the particular type of music media items (e.g., play). Based, at least in part, upon the information received from the data source component 120 and the behavior component 130, the user interface component 110 displays information related to the music media items associated with the selected data sources 140 and available action(s) for the particular type of music items.

With conventional systems, user interface software was modified when support for a new type of media was needed. Accordingly, in order to support new types of media, a user's system would need to be updated frequently. The ever increasing types of media has led to a frustrating experience for many users, for example, when users receive a message indicating that a particular media type is not supported by the current version of the user interface software.

As the system 100 provides an extensible framework in which the user interface component 110 can be maintained independent of the data source component 120 and the behavior component 130, user frustration can be reduced. When a new type of data source is added, the data source component 120 can be modified to include the new type of media and locations of data source(s) 140 of the new type. Further, the behavior component 130 can be modified to include action(s) associated with the new type of media. Since the user interface component 110 receives information from the data source component 120 and the behavior component 130 (e.g., dynamically), the user interface component 110 does not need to be modified in order to support the new type of media (e.g., new file format). The user interface component 110 can present the information associated with the media items of the new type of media received from the data source component 130 and the action(s) associated with the new type of media from the behavior component 120.

Thus, within the framework, the user interface component is functionally independent of the data source component and the behavior component. As media type(s) are modified, the user interface component does not need to be modified in order to support the modification. The modifications occur within the data source component and the behavior component. As such, the user interface component (e.g., user interfaces, features, etc.) can be maintained independent of modifications to the data source component and/or the behavior component.

In one embodiment, the system 100 can be employed to search data source(s) 140 for media item(s) in response to a user search request. In this manner, the search function is a consumer of information provided by the data source component 120 and/or the behavior component 130. For example, a user can search for songs performed by a particular artist which are available for download from the Internet.

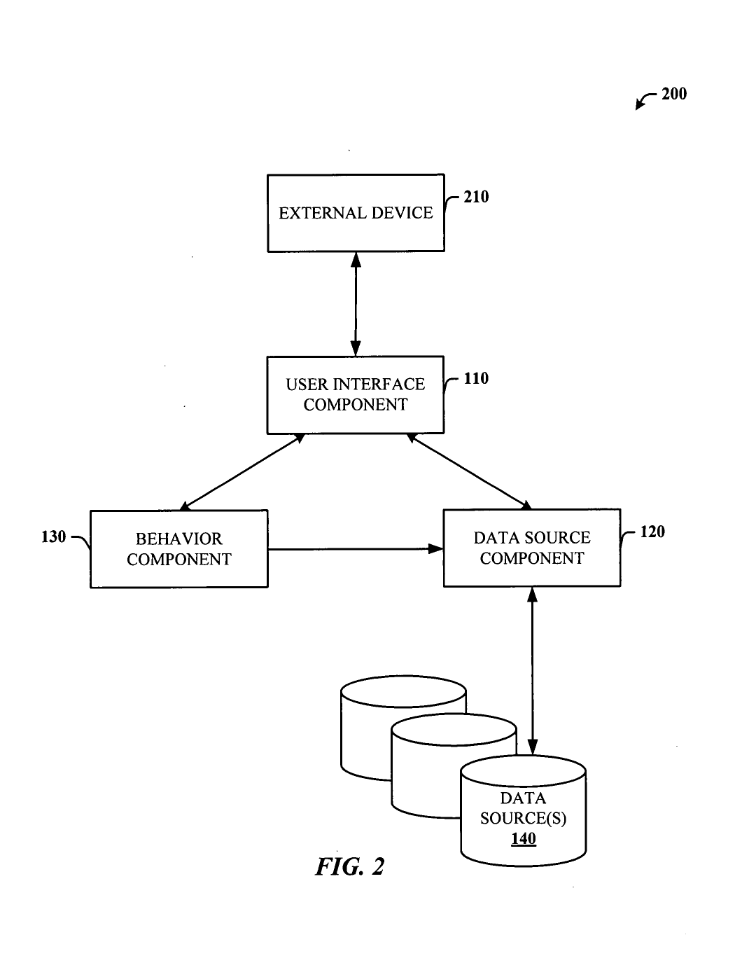

Referring to FIG. 2, a computer-implemented system 200 for interacting with media is provided. The system 200 includes an external device 210 (e.g., remote control) which can facilitate a user's exploration of media (e.g., music, digital photographs, movies, television, etc.) within the extensible framework discussed previously.

The external device 210 can receive information associated with the media items from the user interface component 110 (e.g., metadata, thumbnails, etc.). The external device 210 can further receive information associated with action(s) associated with the type of the media items from the user interface component 110.

In this manner, the external device 210 is an extension of the user interface component 110. As such, firmware and/or software associated with the external device 210 does not need to be modified to support new media types. The external device 210 can present the information associated with the media items of the new type of media and the action(s) associated with the new type of media received from the user interface component 110.

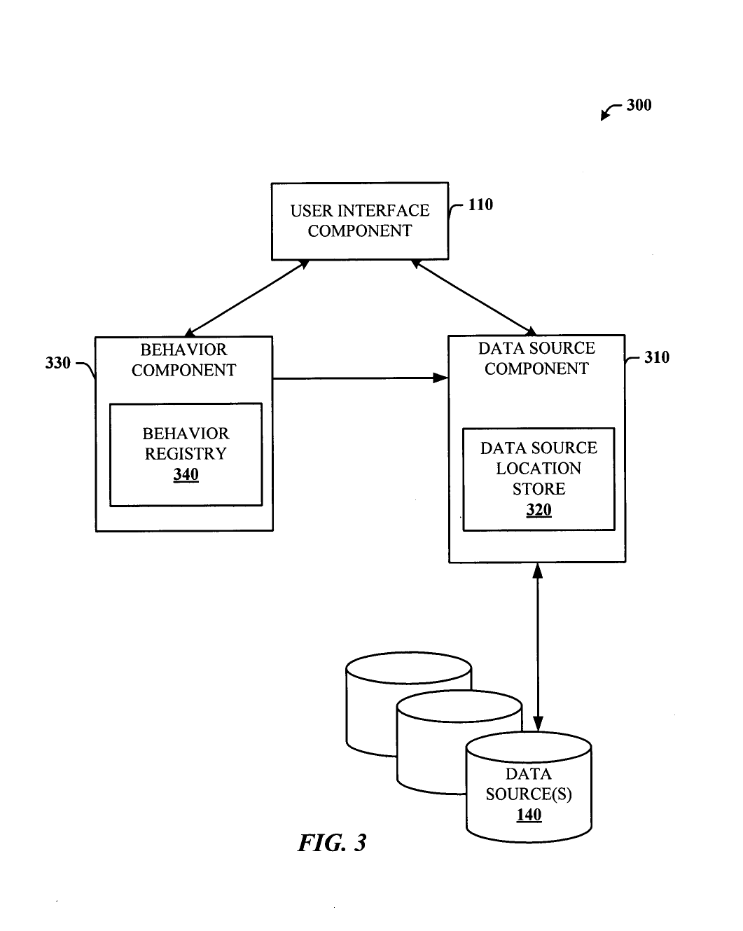

Turning to FIG. 3, a computer-implemented system 300 for interacting with media is provided. The system 300 includes a data source component 310 that stores information associated with the media items (e.g., identifier(s)) and information regarding location(s) of the media items in a data source location store 320. As data source(s) 140 are added or removed, the data source location store 320 can be modified to reflect the changes.

The system 300 further includes a behavior component 330 that stores action(s) associated with types of media in a behavior registry 340. Accordingly, as type of media are modified, added and/or removed, the behavior registry can be modified 340 to reflect the changes.

Changes to the data source location store 320 and/or the behavior registry 340 can be performed independent of modifications, if any, to the user interface component 110. The user interface component 110 receives information regarding the media items and action(s) associated with types of media dynamically. As such, the user interface component 110 is data agnostic as the interface component 110 has no independent knowledge of media items and/or action(s) associated with types of media. Thus, with the data source location store 320 and the behavior registry 340, new data source(s), media type(s) and/or behavior(s)/action(s) can be added without modification to the user interface component 110, the behavior component 330 and/or the data source component 310.

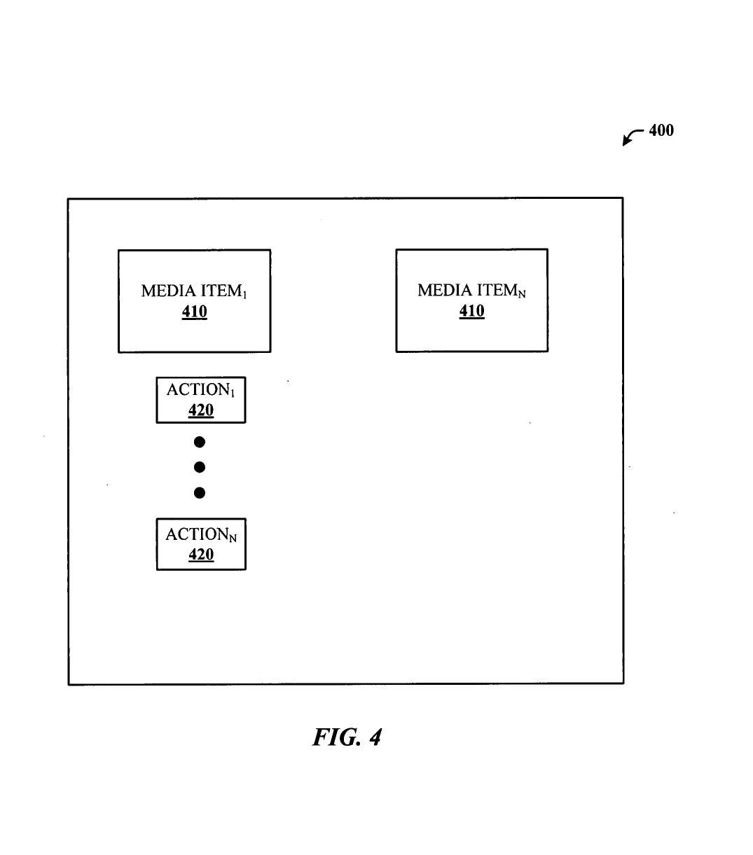

FIG. 4 illustrates an exemplary user interface 400 and includes information associated with a plurality of media items 410 and action(s) 420 associated with the media items. The user interface 400 can be generated by the user interface component 110 with the information associated with the plurality of media items 410 provided by the data source component 120 and the action(s) 420 associated with the media items provided by the behavior component 130. In this example, the media items 410 are of the same type of media—thus, the same action(s) 420 are available for each of the media items 410.

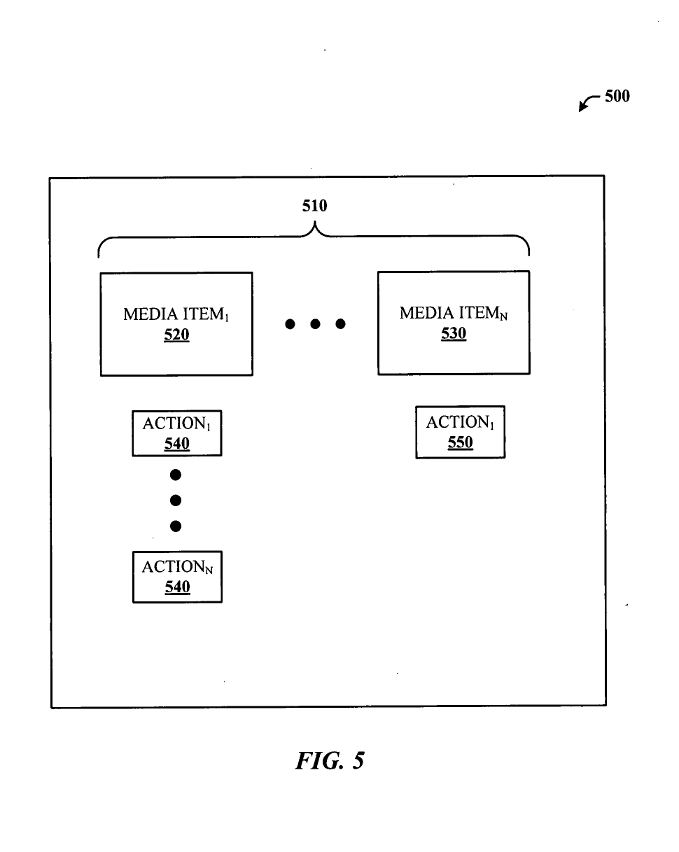

FIG. 5 illustrates an exemplary user interface 500 for displaying information associated with media items 510. In this example, the media items 510 includes a first media item 520 of a first media type and a second media item 530 of a second media type. Also in this example, the first media item 520 has a plurality of actions 540 while the second media item 530 has a single action 550. For example, digital photographs and digital videos taken on a digital camera can be presented in a single gallery, to allow user(s) to see digital memories (e.g., from a vacation).

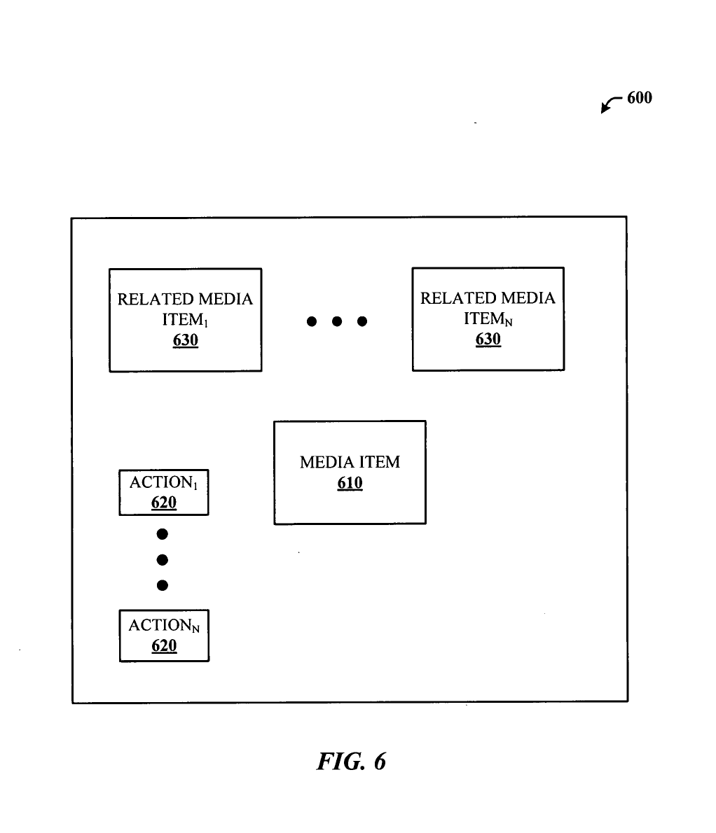

Referring next to FIG. 6, an exemplary user interface 600 for displaying information associated with a media item 610 is illustrated. In this example, one or more actions 620 associated with the media item 610 are displayed. Additionally, the user interface 600 includes one or more related media items 630.

In one embodiment, in order to provide a richer experience for a user, a data source 140 can store information regarding related media items 630 in metadata associated with the media item 610. The data source component 120 can provide this additional information to the user interface component 110 for display to the user. For example, for a music media item (e.g., a song), the data source 140 can store information (e.g., links) related to digital photographs of musicians, an audio file of an interview with the musicians, etc. Accordingly, in this embodiment, the data source 140 can modify the user's experience without modifying the user interface component 110.

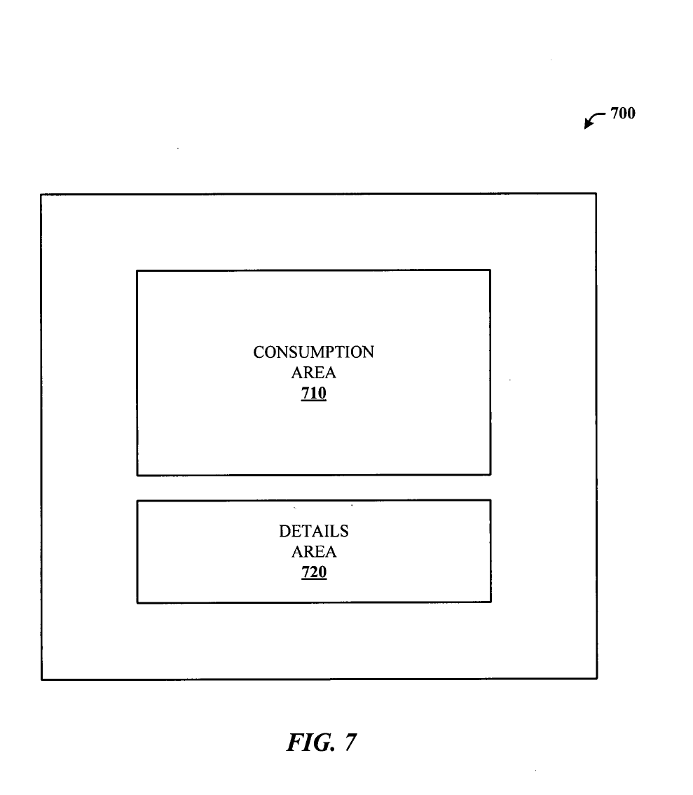

Turning to FIG. 7, an exemplary user interface 700 for displaying a media item in a consumption area 710 is illustrated. In this example, a user has selected to experience the particular media item (e.g., view a digital photograph, listen to a song, etc.). Information about the particular media item is displayed in the consumption area 710. The user interface 700 includes a details area 720 which can display information associated with the media item received from the data source component 710. Thus, the data source 140 can provide information (e.g., rich metadata) to be displayed to the user without requiring modification to the user interface component 110.

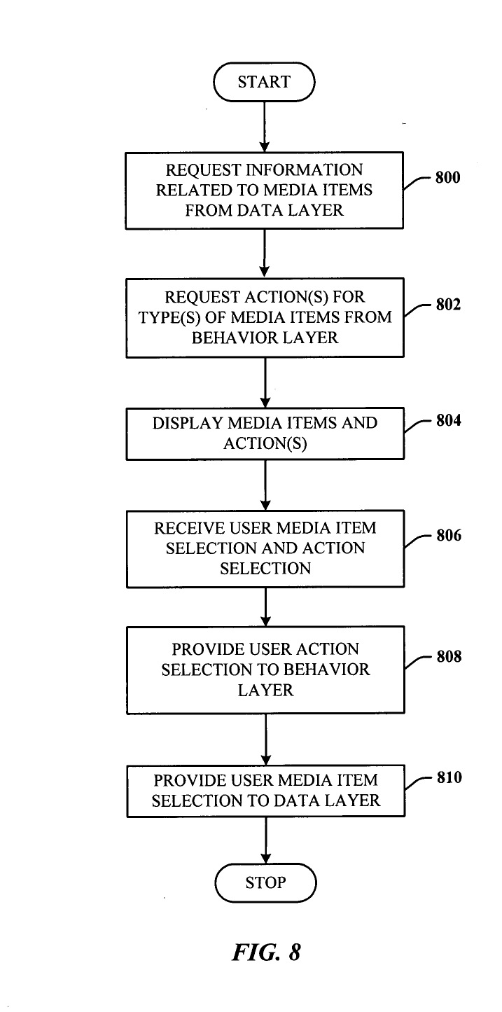

FIG. 8 illustrates a method of displaying information related to media items. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

At 800, information related to media items of a particular type is requested from a data layer (e.g., data source component 120). At 802, information regarding action(s) associated with the particular type of media is requested from the behavior layer (e.g., behavior component 130). At 804, information related to media items and action(s) associated with the particular type of media is displayed. At 806, a user media item selection and action selection is received. At 808, the user action selection is provided to the behavior layer. At 810, user media selection is provided to the data layer.

The method illustrated in FIG. 8 can be performed, for example, by the user interface component 110 within the extensible framework discussed above. The user interface component 110 is data agnostic and is a conduit for information provided by the data layer (e.g., data source component 120) and the behavior layer (e.g., behavior component 130). The user interface component 110 does not need to have any stored information regarding media items and/or action(s) associated with particular types of media.

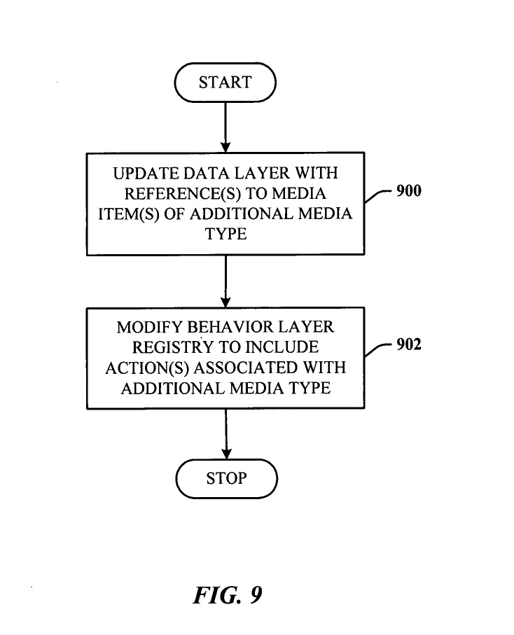

FIG. 9 illustrates a method of recognizing an additional media type. At 900, a data layer is updated with reference(s) to media item(s) of the additional media type. At 902, a registry of a behavior layer is modified to include action(s) associated with the additional media type. In this manner, the additional media types can be recognized by a user interface component 110 without modification to the user interface component 110. This can greatly increase user satisfaction in exploring media in the ever-changing digital media world. As additional media types are created, the user interface component 110 can recognize the additional media types much more rapidly than with conventional systems.

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

While certain ways of displaying information to users are shown and described with respect to certain figures as exemplary user interfaces, those skilled in the relevant art will recognize that various other alternatives can be employed. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

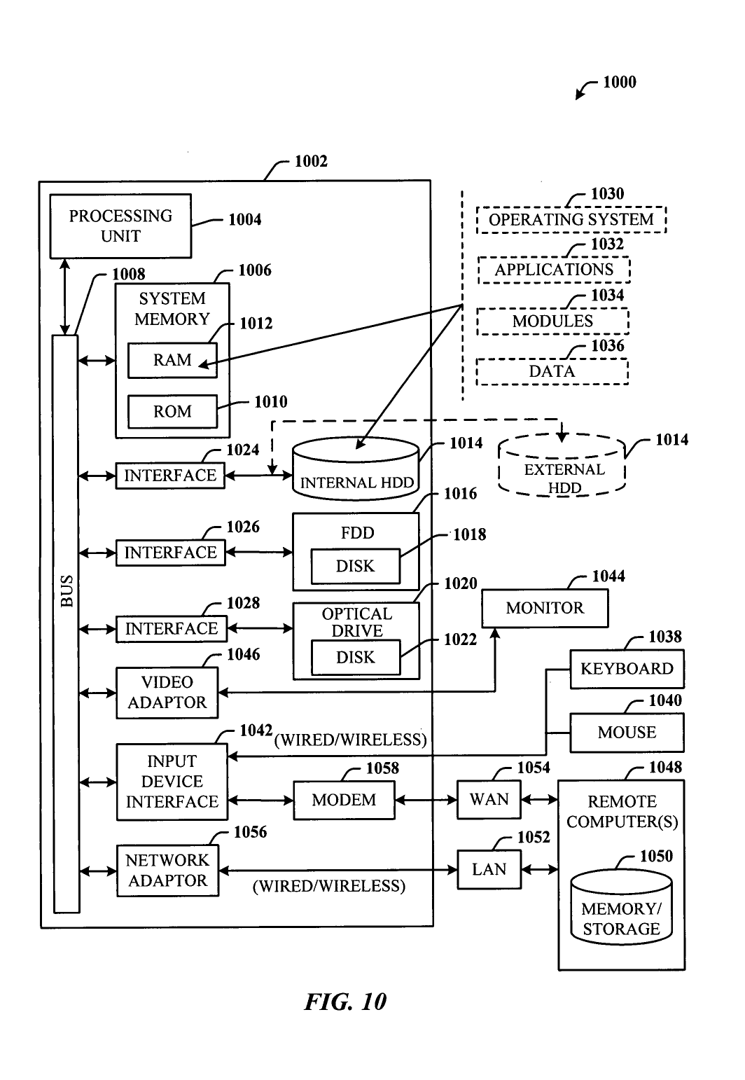

Referring now to FIG. 10, there is illustrated a block diagram of a computing system 1000 operable to execute the disclosed architecture. In order to provide additional context for various aspects thereof, FIG. 10 and the following discussion are intended to provide a brief, general description of a suitable computing system 1000 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 10, the exemplary computing system 1000 for implementing various aspects includes a computer 1002, the computer 1002 including a processing unit 1004, a system memory 1006 and a system bus 1008. The system bus 1008 provides an interface for system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is to be appreciated that the disclosed architecture can be implemented with various commercially available operating systems or combinations of operating systems.

A user can enter commands and information into the computer 1002 through one or more wired/wireless input devices, for example, a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

Referring briefly to FIGS. 1 and 10, the user interface component 110 can provide information to a user via the monitor 1044 and/or other peripheral output devices. Further, the user interface component 110 can received information from the user via the mouse 1040, the keyboard 1038 and/or other input devices.

The computer 1002 may operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, for example, a wide area network (WAN) 1054. Such LAN and WAN networking environments are commonplace in offices and companies, and facilitate enterprise-wide computer networks, such as intranets, all of which may connect to a global communications network, for example, the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, for example, computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

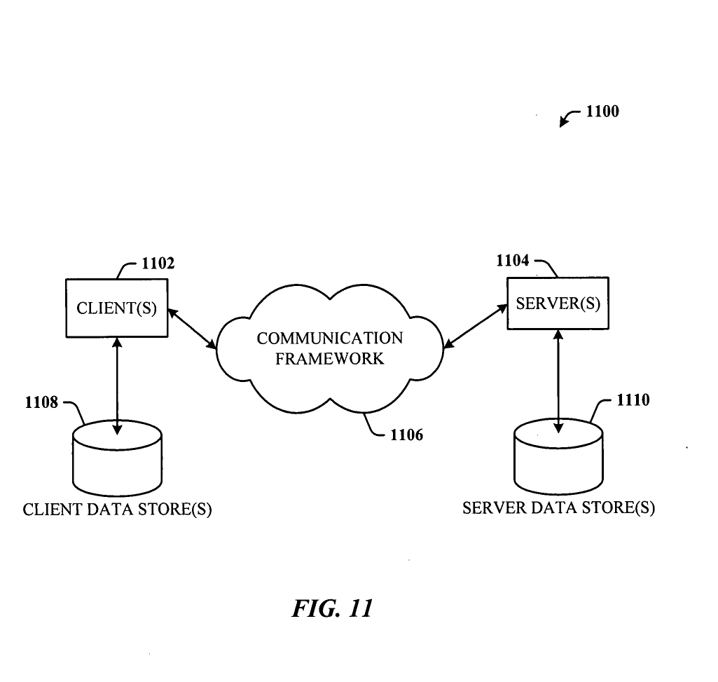

Referring now to FIG. 11, there is illustrated a schematic block diagram of an exemplary computing environment 1100 that facilitates interaction with media. The system 1100 includes one or more client(s) 1102. The client(s) 1102 can be hardware and/or software (e.g., threads, processes, computing devices). The client(s) 1102 can house cookie(s) and/or associated contextual information, for example.

The system 1100 also includes one or more server(s) 1104. The server(s) 1104 can also be hardware and/or software (e.g., threads, processes, computing devices). The servers 1104 can house threads to perform transformations by employing the architecture, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104. Referring to FIGS. 1 and 11, the data source(s) 140 can be stored on the client data store(s) 1108 and/or the server data store(s) 1110.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system for interacting with media, comprising:
a data source component that provides information associated with a media item;
a behavior component that provides information associated with an action, which action is related to a type of the media item; and,
a user interface component for displaying the information associated with the media item and the information associated with the action.

2. The system of claim 1, wherein the user interface component further provides user input information associated with the action to the behavior component.

3. The system of claim 1, wherein the type of media item comprises at least one of a digital photograph file, an audio file, a movie file, a video file, a video stream, or an audio stream.

4. The system of claim 1, wherein the user interface component displays information associated with a plurality of media items.

5. The system of claim 4, wherein the plurality of media items are of a same type.

6. The system of claim 4, wherein the plurality of media items are not all of a same type.

7. The system of claim 1, wherein the information associated with the media item includes one or more related media items.

8. The system of claim 1, wherein the user interface component supports an additional type of media in an unmodified manner.

9. The system of claim 1, wherein the data source component further comprises a data source location store that stores information regarding a location of the media item.

10. The system of claim 1, wherein the behavior component further comprises a behavior registry that stores the action associated with the type of media item.

11. The system of claim 1, wherein the information associated with the media item includes metadata associated with the media item.

12. The system of claim 1, wherein the user interface component displays information in a gallery format.

13. The system of claim 1 employed to search one or more data sources for the media item in response to a user search request.

14. The system of claim 1, further comprising an external device which receives information associated with the media item and the action associated with the type of the media item from the user interface component.

15. The system of claim 1, wherein the media item is stored on a data source local to the system, and the type of media stored thereon comprises at least one of a digital photograph file, an audio file, a move file, or a video file.

16. The system of claim 1, wherein the media item is stored on a data source remote from the system, and the type of media stored thereon comprises at least one of a video stream or an audio stream.

17. A computer-implemented method of displaying information related to media items, comprising:
requesting information related to a plurality of media items from a data layer,
requesting action information for a type associated with the media items; and,
displaying the information related to the plurality of media items and the action information.

18. The method of claim 17, further comprising:
receiving user media item selection and user action selection;
providing the user action selection to a behavior layer; and,
providing the user media item selection to the data layer.

19. The method of claim 17, wherein the plurality of media items are of a same type.

20. A computer-implemented method of recognizing an additional media type, comprising:
updating a data layer with a reference to a media item of the additional media type; and,
modifying a behavior layer registry to include an action associated with the additional media type.
